(19) United States
(12) Patent Application Publication
(10) Pub. No.: US 2006/0009193 A1
(43) Pub. Date: Jan. 12, 2006

(54) Method and system for changing the service level for subscribers in an electronic communications network

(76) Inventor: Paolo Bazzica, Roma (IT)

Correspondence Address: ERICSSON INC., 6300 LEGACY DRIVE, M/S EVR C11, PLANO, TX, 75024, US

(21) Appl. No.: 10/519,607

(22) PCT Filed: Jun. 19, 2003
(86) PCT No.: PCT/SE03/01051

§ 371 Date: Aug. 16, 2005

(30) Foreign Application Priority Data
Jun. 30, 2002 (SE) 0202068-3

(51) Int. Cl. H04M 11/04

(52) U.S. Cl. 455/406

(57) ABSTRACT

A method for changing the service level for a subscriber in an electronic communication network. One or more voucher records (203, 204, 205; 213, 214) are created for one or more kinds of services, wherein each record comprises a voucher quantity (203b, 204b, 205b; 213b, 214b) of vouchers, and an identification parameter for association with one or more service. The records are associated with a subscriber (201, 211) for usage by the subscriber when said services are utilised.

### FIELD OF THE INVENTION

The present invention relates to a method and system for changing the service level for subscribers in an electronic communication network.

### DESCRIPTION OF THE PRIOR ART

All commercial communications networks, for example mobile telephone communications networks including operators and service providers, have a charging system for charging customers utilising the network and different services.

Today's mobile telephone communications networks such as GSM, public switched telecommunications networks (PSTN), ISDN, ATM, Internet etc. provide many different more or less sophisticated tele and data communications services for users and providers, regional as well as world-wide. The demands for increased benefit of the network operator, the service provider, and the service subscriber have brought forth the concept of Intelligent Network (IN). An Intelligent Network is a telecommunications concept that meets the market demand, from network operators and service providers, for advanced services within the existing telephony network. Examples of such services are Premium Rate calls, Mobile virtual Private Network, Prepaid charging and Personal Number. Different network providers offer different sets of services including both charged services and services free of charge.

Charging for usage of mobile telephone communications networks such as GSM, public switched telecommunications networks (PSTN), ISDN, ATM, Internet etc. and their associated services are achieved by means of a payment mechanism or service. Both postpaid and prepaid services are used. On one hand, the service subscriber pays for a service after it has been used, for example once a month, in postpaid service. Contrary, in a prepaid service, the service subscriber or customer pays before the usage of the service.

In prior art pre-paid systems it. is common practice to load an account with money and then deduct the account balance due to subscriber usage. For an ongoing call, the account balance is decreased step by step until it is zero, resulting in that the call is cut off and no charged activity is allowed until the account has been refilled. Of course it is desired by service providers that subscribers or users utilise services as much as possible. One part of achieving this is that service providers give promotions to frequent and large consumers.

In a prior art prepaid system (PPS) provided by the applicant, the subscriber can receive promotions as money amounts to be summed to the actual account balance. It is also possible to add money to sub-accounts dedicated to specific services, e.g a Short Messages sub-account.

This way of handling promotions give some flexibility but the result of the promotions is always reconnected to an amount of money to be added to the subscriber account(s). Also the number of available sub-accounts limits the number of promotions that can be defined.

In this way some very common promotions can't be offered, in fact whenever the tariff for a service is not a fixed rate, it is not possible to translate a bonus on that service, e.g 3 free SMs, to a money amount since the price for that service may vary.

For instance to give “60 minutes of calls towards the numbers in the area 08” is not possible since these calls can have different prices in different daytime intervals. The same reasoning applies to promotions like “10 MB free GPRS download” or “10 bullets for the online game”.

### SUMMARY OF THE INVENTION

It is an object of the present invention to provide an improved method for changing the service level for subscribers in an electronic communication network.

Another object of the present invention is to provide an improved method for utilising communication services provided by the communication network.

This object is achieved by a method for changing the service level for a subscriber in an electronic communication network, wherein one or more voucher records are created for one or more services, each record comprising a voucher quantity of vouchers and an identification parameter for association with one or more services, and wherein the one or more records are associated with a subscriber for usage by the subscriber when utilising the services.

A more specific object of the invention is to provide an improved data processing system and a computer program for working the method.

An advantage of the present invention is that promotions not translatable into an amount of money can be added to a subscriber account. Further it is an advantage that operators of communications systems including the method and system according to the invention are capable to offer discounts to their subscribers for a certain time, volume, service or a combination thereof.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

In order to explain the invention in more detail and the advantages and features of the invention, a preferred embodiment will be described in detail below, reference being made to the accompanying drawings, in which

FIG. 1 is a schematic view of a part of a cellular mobile telephone network,

FIG. 2 is a block diagram of an embodiment of a data structure including a first and a second voucher list forming a part of a system according to the present invention for changing the service level in a communications system,

FIG. 3 is block diagram of another part of the data structure in FIG. 2 comprising fee and rating leafs including voucher settings,

FIG. 4 is a block diagram of the embodiment of the data structure in FIG. 2 including an updated first voucher list according to the present invention, and

FIG. 5 is a block diagram of the embodiment of the data structure in FIG. 2 including also an updated second voucher list according to the present invention.

### DETAILED DESCRIPTION OF THE INVENTION

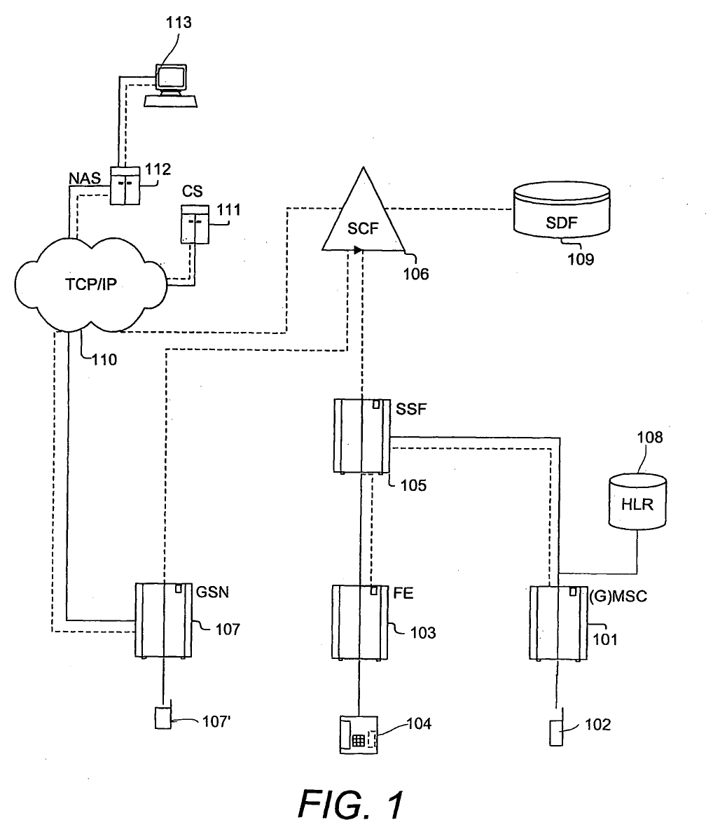

Referring to FIG. 1, there is shown an example of a communications network such as a cellular mobile telephone network or PLMN (public land mobile network) including a service providing network, such as an intelligent network (IN) facilitating service delivery for subscribers connected to the network. In this embodiment, the network also provides a real-time charging mechanism and a method for determining rating data for pre-paid services for subscribers in the communications network. The real-time charging mechanism is only one example of a method for charging for services in a communications network, but this mechanism is not necessary for the invention. This real time charging mechanism supports rating and charging of both prepaid and post paid services. An off-line mechanism or other method of charging is likewise possible within the scope of the invention.

Cellular telephone service, such as GSM/UMTS, involves the subdivision of a service area into a number of smaller cells. Among other components and features, a cellular mobile communications system or PLMN comprises a gateway mobile services switching centre (GMSC) 101 and mobile services switching centre (MSC), which provides specific data about individual mobile phones 102 in the network and operates as an interface towards other networks such as other PLMNs, ISDN or a public switched network (PSTN), represented by a fixed exchange 103 and telephone set 104 in the communications system. The (G)MSC 101 comprises a data processing system, including a computer processor for processing data, and storage means connected to the computer processor for storing data on a storage medium.

Cellular systems are using radio access based on both analogue and digital transmission. Digital cellular systems provide the best quality with the least amount of bandwidth. Different kinds of principles such as TDMA or CDMA technologies are used for digital cellular systems, such as GSM.

The communications system also has an intelligent network IN with a signalling network, which performs message switching between network elements. In this embodiment of the invention, a specific type of signalling protocol, signalling system 7 (SS7), is used as a carrier for the exchange of information messages and carries many types of information elements, which are useful for intelligent network services. However, SS7 is only an example and the signalling protocol can be based on another protocol such as the Internet Protocol (IP), Camel Application Part (CAP) for GSM/UMTS, IN Application Part (INAP) for fixed networks—where CAP and INAP are transported on SS7/C7/SIGTRAN. Additionally, the intelligent network includes a service switching function 105, a gsm service switching function (gsmSSF) in this embodiment. The SSF 105 is in GSM usually located in the (G)MSC 101. The SSF 105 detects events indicating a call requiring IN and after this triggering, it suspends call processing and starts a series of transactions with a service control function 106, a gsm service control function (gsmSCF) in this embodiment. Additionally or as an alternative, the communications system has a service or gateway GPRS support node 107, including a gprs service switching function (gprsSSF), for communication with users of GPRS equipment 107′.

The SCF 106 is a real-time service processing system that, based on a query from the SSF 105, performs subscriber- or application-specific service logic, controlling the call set-up and call flow. A home location register (HLR) 108 stores the identity and user data of all the subscribers belonging to the PLMN. Further, the HLR 108 provides the (G)MSC 101 with the necessary subscriber data when a call is coming from a public switched network (PSTN) 103,104, an ISDN network, the Internet etc. A visitors location register (VLR) of the (G)MSC 101 contains relevant data of all mobiles currently located or roaming within a serving (G)MSC 101. The VLR has to support the (G)MSC 101 during call establishment when a call is coming from a mobile telephone 102.

A service data function (SDF) 109 or point is a database containing service data needed for the service, including for example tariff data, subscriber data, group data etc. In this embodiment, the SDF 109 or SCF 106 also handles rating and charging analysis.

The disclosed embodiment of the communications system according to the invention also includes a TCP/IP network (Internet) 110, a content server (CS) 111 and at least a network access server 112 for communication with computer terminals 113 and their users.

Before a mobile telephone user can make a phone call or use other post or prepaid services provided by the network and service providers, content provider or value added service provider etc., hereafter called providers, he/she has to be registered as a “subscriber”.

As mentioned above, the database of the service data function (SDF) 109 contains service data needed for services, including for example tariff data, subscriber data etc in this embodiment.

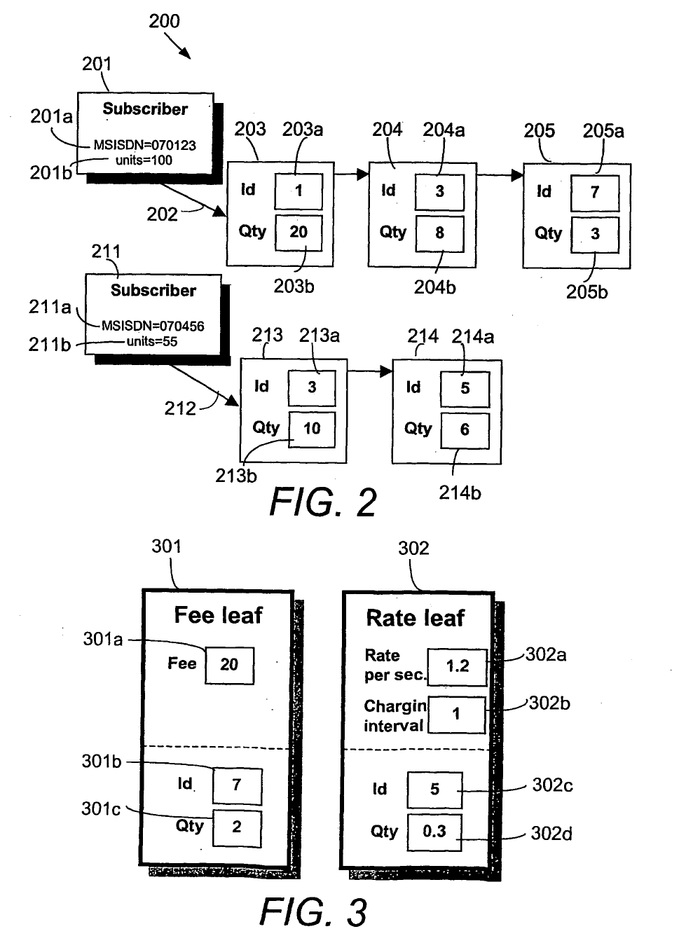

One embodiment of a data structure 200 forming a part of the charging system for changing the service level and utilising communication services according to the invention is shown in FIG. 2. The data structure is stored and handled by the SDF 109 (and SCF 106) shown in FIG. 2.

A first subscriber 201 is identified by a subscriber ID (SubID) 201a, for example MSISDN in GSM. A flexible voucher list FVL 202 is associated with the subscriber 201. The list 202 comprises a sequence of voucher records, in this example three records 203, 204, 205 including a voucher type id 203a, 204a, 205a and a voucher quantity Qty 203b, 204b, 205b. Each record in the list has a voucher quantity (Qty) 203b, 204b, 205b of vouchers related to a specific service identified by the voucher type ids 203a, 204a, 205a, respectively. The first subscriber 201 also has a unit variable 201b, with a value of 100 units for service usage in this embodiment of the invention.

A second subscriber 211 identified by a subscriber ID (SubID) 211a, i.e MSISDN=070456, for the purpose of illustration. The second subscriber 211 has an associated flexible voucher list FVL 212. The list 212 comprises a sequence of voucher records, two records 213, 214, including a voucher type id 213a, 214a, and a quantity Qty 213b, 214b. Each record in the list represents a number (Qty) 213b, 214b, of vouchers related to a specific service, that is for example the target of a particular promotion, identified by the voucher type ids 213a, 214a. The second subscriber 211 also has a unit variable 211b, with a value of 55 units in this embodiment of the invention.

Generally, a rating leaf 301 of type “fee” in a rating tree of the charging system contains a single field: the fee 301a to be applied expressed in units, 20 in this example. According to the invention, it is extended with new fields: a voucher type id 301b and a voucher quantity Qty 301c. These fields, if not empty, specify the type (voucher type id) and the quantity (voucher quantity) of vouchers corresponding to the fee 301a for a particular service.

Further, a rating leaf 302 of type “rate” contains two fields, an amount or rate 302a to be deducted to rate an interval (units) and the charging interval 302b to be rated (in seconds). This leaf 302 is extended with new fields: a voucher type id 302c and a voucher quantity 302d. These fields, if not empty, specify the type (voucher type id) and the quantity (Qty) of vouchers corresponding to the rate for the specified interval.

When the charging system analyses the rating tree including the one or more rating leafs 301, 302 to charge for a service, the specified amount of units or the specified voucher quantity according to the contents of the leafs 301 and 302, respectively are decreased from the subscriber's available units or associated voucher record.

To leave the voucher section empty in the rate and fee leafs 301, 302 would mean that no voucher can be used to pay for the service, but only with available units.

To fill the voucher section while leaving the “fee” or “rate” fields empty in the leafs 301, 302 would mean that the use of the entered voucher types is the only way to charge for that service.

If a subscriber should send an originating SM (Short Message), such as an SMS (Short Message Service), the rating is set with the fee specified in the fee leaf 301. This means that an originating SM can be paid either with 20 account units or with 2 vouchers of type (Id) 7.

Considering the subscribers 201 and 211 in FIG. 2, the subscriber 201 with the MSISDN=070123 that has to pay for an originating SM will do that using 2 units of the voucher type id=“7”. Instead, the subscriber 211 with the MSISDN=070456, not having any voucher type of Id=“7”, will have his account 211b deducted by 20 units.

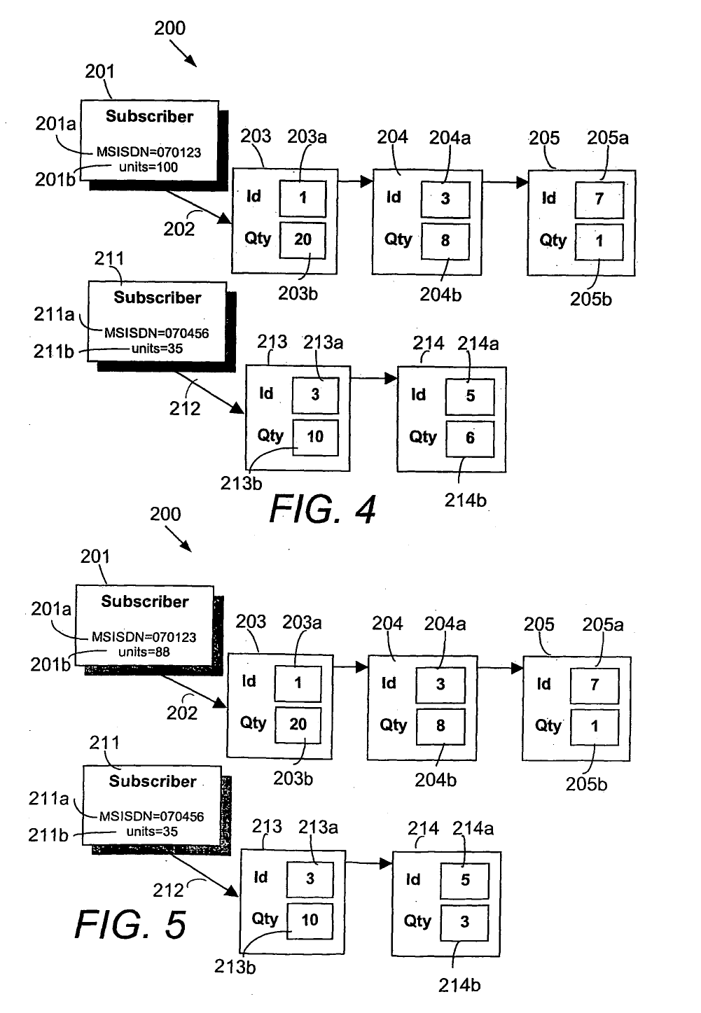

The situation after the payment of the fee by the two users is illustrated in FIG. 4. The first subscriber 201 has now 1 unit of Qty 205b left of the voucher type id=“7” 205a, and the second subscriber 211 has 35 units left.

For originating voice calls towards a B-no beginning with 08, the rating leaf 302 is used for the rate. This means that one second of call towards “08” can be paid with 1.2 account units 302a or alternatively with 0.3 vouchers 302d of type Id=5 302c.

The subscribers 201 and 211 are in the state specified in FIG. 4. Both subscribers make an originating call towards 08 with a deduction time of 10 seconds. The rating of that period would leave the two subscribers in the state specified in FIG. 5, i.e the first subscriber 201 has 88 units left and the second subscriber 211 has now 3 units of Qty 214b left of the voucher type id=“5” 214a.

The rating function of the service data function (SDF) 109 or SCF is a decision tree that branches on the available input parameters (i.e. the time of the day), where the leafs define the price to pay for the service.

It has the possibility to use the vouchers that are in the subscriber's FDL 202, 212, instead of the subscriber's money to pay the requested service.

When a price is determined the (optional) possibility to use a number of vouchers of a certain Id should be given in the rating component, i.e the computer program code means and/or computer hardware means performing the rating in the system as an alternative option to pay for the service, instead of the money.

The rating tree leafs could be further enhanced adding a percentage field to the voucher section (values from 0% to 100%). This would specify the max. percentage of the service that is payable using the vouchers.

This extension would make possible promotions like: “Pay the first 50 SMs with a 50% discount and the rest at full price” by provisioning 50 vouchers for SMs to the subscriber with the discount factor set to 50%.

Since the voucher types in the list are identified by Ids and the binding between the Id and the use of that kind of voucher, the FVL can be used to promote any service.

E.g. the voucher with Id=“1” 203a could be associated by an operator to “Free SM” and therefore Qty=“20” 203b would represent “20 free SM”. Another operator could use the voucher with Id=“1” to identify the “bullets for the on-line game” and therefore Qty=“20” 203b would represent “20 free bullets”. Further, but not limiting, examples of services that can be promoted by the method according to the invention are EMS (Enhanced Messaging Services), MMS (Multimedia Messaging Service), volume of data, time of service usage or a monetary value etc..

The voucher records could be further enhanced by adding an expiry date to each voucher record.

In this embodiment of the invention only two subscribers 201 and 211 have been described. However, the invention is not limited to two subscribers, but it is equally applicable to a system with one or more subscribers A subscriber is linked to an account but an account can be referred by many subscribers. The FVL, could be provided on both the account level, i.e it is applicable to all the subscribers linked to that account, and the subscriber level as well, i.e it is applicable only for that particular subscriber. If FVL is present at both levels then the FVL to use would be the one resulting from the union of the subscriber list and the account list. Vouchers would be deducted from the FVLs starting with the subscriber list.

Further, each list associated with the subscribers can comprise one or more records, wherein each record represents values for individual services. The term list is used herein as a conceptual denomination but the actual implementation may vary. Normally, a simple table would be used but other data structures as linked lists, trees etc. could be used as well.

The method of the present invention is preferably implemented in computer software executable preferably by a central or distributed data processing system forming part of the overall communication system for communication with other devices, components or data processing system/s in the communications system of the network or networks. In one embodiment of the data processing system, i.e the SCF 106, according to the invention, it comprises a computer processor for processing data in the operator, and at least a storage connected to the computer processor for storing data, such as the database of the SDF 109, on a storage medium. In this embodiment of the invention, the computer processor of the operator in the network is configured to work the steps of the method.

Hence, it should be apparent that the present invention provides an improved method and system for use in an electronic communications system or network, comprising a rating and charging mechanism that provides an improved charging system and method for changing the service level for subscribers in an electronic communication network and utilising communication services provided by the communication network that fully satisfies the aims and advantages set forth above. Although the invention has been described in conjunction with a specific embodiment thereof this invention is susceptible of embodiments in different forms, with the understanding that the present disclosure is to be considered as an exemplification of the principles of the invention and is not intended to limit the invention to the specific embodiments illustrated.

Although the method is described in conjunction with a mobile telephone call in an intelligent/CAMEL network of a mobile communications system, such as GSM, the method is applicable on any communication session, both terminating and originating, and other communication services in other kind of networks. For example, the method and system according to the invention are applicable in other mobile telephone networks, public switched telecommunications networks (PSTN), ISDN, ATM, Internet etc., which provide many different more or less sophisticated tele and data communications services, such as for users and providers.

1. A method for changing the service level for a subscriber in an electronic communication network, comprising the steps of:
creating one or more voucher records for one or more services, wherein each record comprises a voucher quantity of vouchers and an identification parameter for association with one or more services, and
associating said one or more records with a subscriber for usage by said subscriber when utilizing said services.

2. The method according to claim 1 further comprising the steps of:
creating one or more rating records in a rating structure for storage of a fee of units to be charged for service usage, further comprising a voucher type identification and a voucher quantity, specifying the type and the quantity of vouchers corresponding to said fee for a particular service.

3. The method according to claim 1, further comprising the steps of:
creating one or more rating records in a rating structure for storage of an amount or rate of units to be deducted to rate an interval and a charging interval to be rated, a voucher type identification and a voucher quantity, specifying the type and the quantity of vouchers corresponding to the rate for said interval.

4. The method according to claim 2 further comprising the steps of:
receiving an incoming charging request from a service element for service usage,
analysing said rating structure for said charging request,
if there is a condition in said rating structure for said request, finding a resulting rating record for return to said request,
if said rating record comprises a voucher type identification and if a record, having an identification corresponding to said voucher type identification of said rating record, is available for said user,
decreasing the voucher quantity of said voucher record with a value corresponding to the consumed service.

5. The method according to claim 3 wherein said rating records have has a discount percentage value that fixes the maximum percentage of the service usage that is payable using the vouchers for a particular service that can be paid using the vouchers.

6. The method according to claim 1, wherein said voucher records is arranged in a list associated with said subscriber.

7. The method according to claim 1, wherein said voucher records has an expiry date.

8. The method according to claim 5, wherein, if a priority order for the usage of said voucher record, having a voucher type identification corresponding to said voucher type identification of said rating record, or another unit of payment associated with said subscriber is available, the voucher record or unit of payment is selected for decrease according to said priority order.

9. The method according to claim 8, wherein said priority order is modified by the subscriber.

10. The method according to claim 1, wherein said quantity or unit is a number of SMS, EMS, MMS, volume of data, time of service usage or a monetary value.

11-12. (canceled)

13. A system for changing the service level for a subscriber in an electronic communication network, said system comprising:
means for creating one or more voucher records for one or more services, wherein each record comprises a voucher quantity of vouchers and an identification parameter for association with one or more services, and
means for associating said one or more records with a subscriber for usage by said subscriber when utilizing said services.

14. The system according to claim 13, further comprising:
means creating one or more rating records in a rating structure for storage of a fee of units to be charged for service usage,
further comprising a voucher type identification and a voucher quantity, specifying the type and the quantity of vouchers corresponding to said fee for a particular service.

15. The system according to claim 13, further comprising:
creating one or more rating records in a rating structure for storage of an amount or rate of units to be deducted to rate an interval and a charging interval to be rated, a voucher type identification and a voucher quantity, specifying the type and the quantity of vouchers corresponding to the rate for said interval.

16. The system according to claim 14, further comprising:
means for receiving an incoming charging request from a service element for service usage,
means for analyzing said rating structure for said charging request,
if there is a condition in said rating structure for said request, finding a resulting rating record for return to said request,
if said rating record comprises a voucher type identification and if a record, having an identification corresponding to said voucher type identification of said rating record, is available for said user, and
means for decreasing the voucher quantity of said voucher record with a value corresponding to the consumed service.

17. The system according to claim 15, wherein said rating records have a discount percentage value that fixes the maximum percentage of the service usage that is payable using the vouchers for a particular service that can be paid using the vouchers.

18. The system according to claim 13, wherein said voucher records are arranged in a list associated with said subscriber.

19. The system according to claim 13, wherein said voucher records have an expiry date.

20. The system according to claim 17, wherein, if a priority order for the usage of said voucher record, having a voucher type identification corresponding to said voucher type identification of said rating record, or another unit of payment associated with said subscriber is available, the voucher record or unit of payment is selected for decrease according to said priority order.

21. The system according to claim 19, wherein said priority order is modified by the subscriber.

22. The system according to claim 13, wherein said quantity or unit is a number of SMS, EMS, MMS, volume of data, time of service usage or a monetary value.
